(19) United States
(12) Patent Application Publication
(10) Pub. No.: US 2016/0332474 A1
(43) Pub. Date: Nov. 17, 2016

(54) COIL PRESSING MACHINE WITH A NEW TRANSMISSION MECHANISM

(71) Applicant: Qingdao H.Y. Corporation, Qing Dao (CN)

(72) Inventor: Yang Yu, Qing Dao City (CN)

(73) Assignee: Qingdao H.Y. Corporation, Qing Dao (CN)

(21) Appl. No.: 14/984,337

(22) Filed: Dec. 30, 2015

(30) Foreign Application Priority Data
May 12, 2015 (CN) 20152031669.4

(51) Int. Cl. B42B 5/10

(52) U.S. Cl. CPC B42B 5/103

(57) ABSTRACT

A coil pressing machine with a new transmission mechanism, wherein the push ring transmission mechanism is a four bar mechanism. The first bar of the four bar mechanism with rocker arm moves in a swinging motion and is connected to the power device. The end of the fourth bar of the four bar mechanism is a roller. The fourth bar of the four bar mechanism and the third bar of the four bar mechanism is connected by a bearing in a permanent angle. The roller and the fourth bar operate in a circular oscillating motion. The roller touches the sliding block of the push ring device. The four bar mechanism can transmit the power efficiency with a simple structure.

The present application incorporates by reference the subject matter of U.S. patent application Ser. No. 14/524,504.

### TECHNICAL FIELD

This invention relates to a coil pressing machine with a new transmission mechanism.

### BACKGROUND

Known coil pressing machines used in domestic offices take a binding coil from a coil stationary box and attach it to a bundle of papers that already have been punched and then press it manually or electrically. Most foreign machines also adopt this binding method. However, German RENZ has a machine, which can automatically take coils and press files electrically, but this machine requires special packing of a dual coil, which occupies much space and has a low efficiency and high cost. Therefore, an automatic ring-picking binding machine suitable for our coil stationary box is needed, however, such a device is not available in the market.

Chinese application number CN103057297A discloses a push ring device and a coil pressing machine. The power transmission mechanism of the push ring device has a belt transmission and a gear transmission, which cannot transmit effectively and has a complicated structure, resulting in a high power loss and high cost. Thus, a coil pressing machine with a simple and efficient power transmission mechanism is needed.

### SUMMARY

This present invention overcomes the above defects by providing a coil pressing machine with a new transmission mechanism which can transmit the power simply and effectively.

The specific technical proposal of the present invention is described below.

The coil pressing machine has a new transmission mechanism which comprises a machine casing and a machine rack. A push ring device, a power device, a transmission device and a binding device are set within the machine casing. The power device is a motor in which the transmission device transmits power from the power device to the push ring device and the binding device. The push ring device comprises a push ring transmission mechanism and a push ring mechanism. The push ring transmission mechanism is connected to the transmission device. The push ring transmission mechanism comprises a four bar mechanism. The first bar of the four bar mechanism comprises a rocker arm which moves in a swinging motion connected with the power device. The end of the fourth bar of the four bar mechanism is a roller. The fourth bar of the four bar mechanism and the third bar of the four bar mechanism are connected by a bearing in a permanent angle. The roller and the fourth bar operate in a circular oscillating motion. The roller touches the sliding block of the push ring device.

The push ring device is set in the machine rack. The push ring device comprises a push board, a push board rail, a plug board, and a plug board rail. The push board is permanently connected with the sliding block. The push board connects with the plug board and the plug board moves through the plug board rail in a horizontal direction.

Both the push board and the plug board are inclined boards and the plug board comprises a card slot which can hold the coil card board.

The plug board also comprises a stop pawl. The push board comprises a notching and the stop pawl is set inside the notching. The push board can push in a linear direction with the cooperation of the notching and stop pawl. The push board is connected with the push board rail. The plug board with the cooperation of the stop pawl pushes the push board which then moves horizontally on the push board rail. One push board and one plug board are viewed as a group.

The hooks of the coil pressing machine are set below the push ring device. The hooks can move left and right. The ratio of coils and the hooks may be in the range of 2:1 or 3:1.

There is a threaded twist which is set in the hooks. The threaded twist adjusts the distance between the machine casing and the hooks.

The distance between every hook of the hooks may be in multiples of 25.4 mm. In some implementations, the distance between every hook of the hooks may vary.

A coil pressing machine also comprises a clutch switch which controls the push ring device and the binding device.

The push ring transmission mechanism is a four bar mechanism. The first bar of the four bar mechanism comprises a rocker arm which moves in a swinging motion and is connected to the power device. The end of the fourth bar of the four bar mechanism is a roller. The fourth bar of the four bar mechanism and the third bar of the four bar mechanism are connected by a bearing in a permanent angle. The roller and the fourth bar move in a circular oscillating motion. The roller touches the sliding block of the push ring device. The power is transmit by the four bar mechanism. The many benefits of the four bar mechanism described above results in having a good power transmission efficiency, convenient assembly, a low cost, and saving resources, which provides a strong practicality.

The push ring device is set in the machine rack. The push ring device comprises a push board, a push board rail, a plug board, and a plug board rail. The push board is connected to the sliding block. The push board connects with the plug board and the plug board can move through the plug board rail horizontally. The present coil pressing machine also comprises hooks. The hooks are below the push ring device and are fixed in front of the machine casing. The hooks can be adjusted to match the different coils. The coils can be placed into the card slots without considering the distance between the card slots. The coils are neatly arranged and then the position of coils and fixed the coils may be adjusted. As a result, the structure of the coil pressing machine is simple and the practicality of the coil pressing machine is strong.

The coil pressing machine also comprises hooks. The hooks are below the push ring device and fixed in front of the machine casing. The position of the hooks is adjustable. Thus, the coil pressing machine with its simple structure results in a low cost and strong practicality since it may be adjusted to accommodate different size coils.

Both the push board and the plug board are inclined boards and the plug board comprises a card slot which can hold the coil card board. Thus, the coils can fall accurately.

The plug board also comprises a stop pawl and the push board comprises a notching. The stop pawl is set inside the notching. The push board can push in a linear direction with the cooperation of the notching and stop pawl. The push board moves in the plug board with the cooperation of the notching and stop pawl to push the coils. Meanwhile, the push board and the plug board are connected by a latch, thus the plug board and the push board can move horizontally together.

The push board is connected with the push board rail. In accordance with the driving of the stop pawl, the plug board moves horizontally in the push board rail. The assembly of the stop pawl achieves synchronous movement of the plug board and the push board. The position of the plug board may be adjusted to accommodate the coil card slot. The push board can synchronize movement. Thus, the coils can be pushed utilizing a simple structure.

One push board and one plug board are viewed as a group. The group can be adjusted according to different working conditions with a reasonable structure and strong practicality.

The hooks can move left and right. The ratio of coils and hooks are in the range of 2:1 or 3:1. With the coils falling down, the position of the coils falling into the hooks may have a deviation. In order to avoid the deviation and improve the binding precision, the hooks can move left and right. The ratio of coils and hooks can be adjusted to the range of 2:1 or 3:1.

There is a threaded twist in the hooks. The threaded twist can adjust the distance between the machine casing and the hooks. According to the different size of the coils, the distance between the machine casing and the hooks can be adjusted. Thus, this structure can accommodate different kinds of coils with a simple structure.

The distance between every hook of hooks may be in multiples of 25.4 mm, which is the least common multiple of the gap in the coils. Thus, under the range of multiples of 25.4 mm, the coils can be fixed by hooks accurately.

A coil pressing machine also comprises a clutch switch which controls the push ring device and the binding device. The clutch switch can control the push ring device and the binding device while running both together and independently. When the binding device cannot bind the coils accurately, the clutch switch controls the push ring device and stops work and the binding device still binds the coils.

### BRIEF DESCRIPTION OF THE DRAWINGS

FIG. 1 is a structure diagram of a coil pressing machine with a new transmission mechanism. The elements in FIG. 1 comprise: 1. machine casing; 2. machine rack; 3. the first bar of the four bar mechanism; 4. push board; 5. push board rail; 6. plug board rail; 7. plug board; 8. stop pawl; 9. coil damper; 10. the first bar of the four bar mechanism; 11. the third bar of the four bar mechanism; 12. the fourth bar of the four bar mechanism; 13. roller; 14. sliding block; 15. power device; 16. hooks; 17. threaded twist.

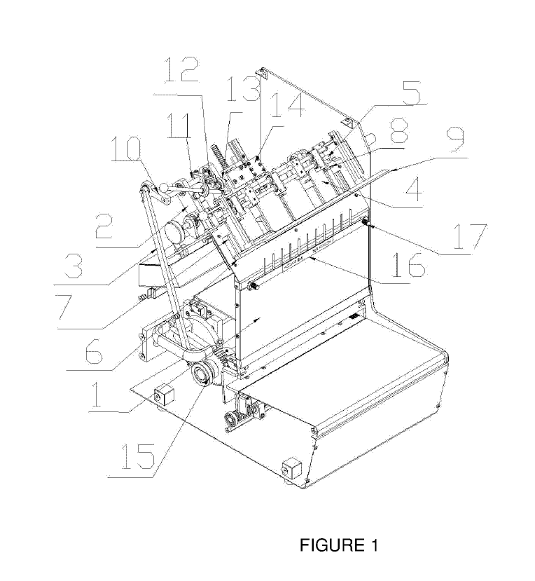

### DETAILED DESCRIPTION OF THE PREFERRED EMBODIMENT

### Embodiment One

The coil pressing machine with a new transmission mechanism comprises a machine casing 1 and a machine rack 2. The push ring device, a power device, a transmission device, and a binding device are set inside of the machine casing 1. The power device is a motor. The transmission device transmits power of the power device to the push ring device and binding device. The push ring device comprises a push ring transmission mechanism and a push ring mechanism. The push ring transmission mechanism is connected with the transmission device. The push ring transmission mechanism is a four bar mechanism. The first bar 3 of the four bar mechanism comprises a rocker arm which moves in a swinging in a motion and is connected to the power device 15. The end of the fourth bar 12 of the four bar mechanism is a roller 13. The fourth bar 12 of the four bar mechanism and the third bar 11 of the four bar mechanism are connected by a bearing in a permanent angle. The roller 13 and the fourth bar 13 move in a circular oscillating motion. The roller 13 touches the sliding block 14 of the push ring device. The push ring device is set in the machine rack 2. The push ring device comprises a push board 4, a push board rail 5, a plug board 7 and a plug board rail 6. The push board 4 is permanently connected to the sliding block 14. The push board 4 connects to the plug board 7 and the plug board 7 moves through the plug board rail 7 in a horizontal direction. Both the push board 4 and the plug board 7 are inclined boards and the plug board 7 comprises a card slot which can hold the coil card board. The plug board 7 also comprises a stop pawl 8 and the push board 4 comprises a notching. The stop pawl 8 is set inside the notching. The push board 4 can push linearly with the cooperation of the notching and stop pawl 8. The push board 4 is connected with the push board rail 5. The plug board 7 with the cooperation of the stop pawl 8 pushes the push board 5 horizontally on the push board rail 5. One push board 4 and one plug board 7 are viewed as a group. The hooks 16 of the coil pressing machine are set below the push ring device. The hooks 16 can move left and right. The ratio of coils and hooks 16 are in the range of 2:1 or 3:1. The threaded twist 17 is set in the hooks 16. The threaded twist 17 can adjust the distance between machine casing 1 and the hooks 16. The distance between every hook of the multiple hooks is in the multiples of 25.4 mm. A coil pressing machine also comprises a clutch switch which controls the push ring device and the binding device.

The power of the transmission device is transmitted by a four bar mechanism. The first bar 3 of the four bar mechanism comprises a rocker arm which moves in a swinging motion and is connected to the power device 15. The end of the fourth bar 12 of the four bar mechanism is a roller 13. The fourth bar 12 of the four bar mechanism and the third bar 11 of the four bar mechanism are connected by a bearing in a permanent angle. When the power device 15 is engaged, the head end of the first bar 3 of the four bar mechanism has a rocker arm moving in a swinging motion. Thus, the second bar 10 of the four bar mechanism views the third bar 11 of the four bar mechanism as the center shaft and moves in a circular motion. The twirl of the third bar 11 of the four bar mechanism leads the fourth bar 12 of the four bar mechanism by a rocker arm swinging motion. The sliding block 14 is moved by the drive of roller 13 and the sliding block drives the push board 4 in a reciprocal motion. Adjusting the position of plug board 7 can accommodate the position of coil card board. The binding process is completed by inserting the coil card board in the plug board 2, adjusting the angle of the coil damper 9, fixing the coil card board by coil damper 9, engaging the push board 4 to push the coils in the binding process, the coils falling to the hooks 16, the hooks fixing the coil, the coils falling to the binding device through the gap between the hooks, the machine casing 1 and binding device binding the coil. When the coils cannot fall accurately, the hooks can be adjusted. The ratio of coils and hooks 16 can be adjusted to the range of 2:1 or 3:1. The clutch switch can control the push ring device and the binding device running both together and independently. When the binding device cannot bind the coils accurately, the clutch switch can control the push ring device to stop working and meanwhile the binding device may still bind the coils.

### Embodiment Two

The difference between the embodiment one and embodiment two is there are two groups of plug boards and push boards in embodiment two.

### Embodiment Three

The difference between the embodiment one and embodiment three is there are three groups of plug boards and push boards in embodiment three.

### Embodiment Four

The difference between the embodiment one and embodiment four is the distance between every hook of the hooks is two times 25.4 mm.

The above description is an implementation of this invention, and the protection range of this invention is not limited to above implementation, instead, all technical proposals belong to this invention are within the protection range. As for the technicians in this field, any modification or trimmings related to the principle of this invention should be considered within the protection range.

What is claimed is:

1. A coil pressing machine with a new transmission mechanism comprising:
a machine casing;
a machine rack;
a push ring device;
a power device;
a transmission device;
a binding device;
wherein the push ring device, the power device, the transmission device, and the binding device are all arranged in the machine casing,
wherein the power device is a motor and the transmission device transmits power of the power device to the push ring device and binding device,
wherein the push ring device comprises a push ring transmission mechanism and a push ring mechanism, and
wherein the push ring transmission mechanism is connected with the transmission device and comprises a four bar mechanism,
a first bar of the four bar mechanism comprising a rocker arm swinging motion is connected with the power device; and
an end of a fourth bar of the four bar mechanism is roller,
wherein the fourth bar of the four bar mechanism and a third bar of the four bar mechanism is connected by bearing in a permanent angle,
wherein the roller and the fourth bar move in a circular oscillating motion, and
wherein the roller touches a sliding block of the push ring device.

2. The coil pressing machine with the new transmission mechanism of claim 1,
wherein the push ring device is set in the machine rack,
wherein the push ring device comprises a push board, a push board rail, a plug board, and a plug board rail,
wherein the push board is permanently connected to the sliding block, and
wherein the push board connects to the plug board and the plug board moves through the plug board rail in a horizontal direction.

3. The coil pressing machine with the new transmission mechanism of claim 1, wherein both the push board and the plug board are inclined boards and the plug board comprises a card slot which holds the coil card board.

4. The coil pressing machine with the new transmission mechanism of claim 3,
wherein the plug board further comprises a stop pawl and the push board comprises a notching; wherein the stop pawl is set inside the notching,
wherein the push board pushes linearly with the notching and stop pawl,
wherein the push board is connected with the push board rail, and
wherein the plug board with the stop pawl pushes the push board in a horizontal direction into the push board rail.

5. The coil pressing machine with the new transmission mechanism of claim 4, wherein one push board and one plug board are a group.

6. The coil pressing machine with the new transmission mechanism of claim 1, wherein the hooks of the coil pressing machine are set below the push ring device, the hooks move left and right, and the ratio of coils and hooks are 2:1 or 3:1.

7. The coil pressing machine with the new transmission mechanism of claim 1, wherein the hooks further comprise a threaded twist and the threaded twist adjusts the distance between machine casing and hooks.

8. The coil pressing machine with the new transmission mechanism of claim 7, wherein the distance between every hook of the hooks is in multiples of 25.4 mm.

9. The coil pressing machine with the new transmission mechanism of claim 1, wherein the coil pressing machine further comprises a clutch switch which controls the push ring device and the binding device running independently.

10. The coil pressing machine with the new transmission mechanism of claim 6, wherein the hooks further comprise a threaded twist and the threaded twist adjusts the distance between machine casing and hooks.
